(19) United States
(12) Patent Application Publication
(10) Pub. No.: US 2018/0069874 A1
(43) Pub. Date: Mar. 8, 2018

(54) ATTACK DETECTION APPARATUS

(71) Applicant: MITSUBISHI ELECTRIC CORPORATION, Tokyo (JP)

(72) Inventors: Minoru SAEKI, Tokyo (JP); Takeshi SUGAWARA, Tokyo (JP)

(73) Assignee: MITSUBISHI ELECTRIC CORPORATION, Tokyo (JP)

(21) Appl. No.: 15/563,067

(22) PCT Filed: May 15, 2015
(86) PCT No.: PCT/JP2015/064025

§ 371 Date: Sep. 29, 2017

(51) Int. Cl. H04L 29/06; G01R 31/02; G01R 31/30; B60R 16/023; H04L 12/28; H04L 12/40; H04L 29/08

(52) U.S. Cl. CPC H04L 63/1416; G01R 31/025; G01R 31/3004; H04L 2012/40215; H04L 12/28; H04L 12/40; H04L 67/12; B60R 16/023

(57) ABSTRACT

The present invention relates to an attack detection apparatus that detects an attack against a communication network between devices, and improves information security of the communication network.

The attack detection apparatus has a CAN (Controller Area Network) that transfers a signal to a plurality of nodes by a differential voltage between two signal lines, and a short circuit detector that monitors the signal transferred by the two signal lines of the CAN, and detects a short circuit between the two signal lines on the basis of a change in the signal indicating a characteristic of a short circuit attack by an unauthorized node.

### TECHNICAL FIELD

The present invention relates to an attack detection apparatus that detects an attack against a communication network between devices and improves information security of the communication network.

### BACKGROUND ART

As a communication network between devices, CAN (Controller Area Network) is widely known. CAN was first developed as communication technology between in-vehicle devices, and then standardized as ISO 11898 and ISO 11519. CAN is now adopted in a wide range of fields, such as industrial equipment and medical equipment, in addition to in-vehicle networks. CAN is divided into high-speed CAN and low-speed CAN depending on the transmission rate. The protocol is common to both of them, but the maximum transmission rate and the physical layer are different. Background art will be described below on the assumption of high-speed CAN.

As described in Non-Patent Literature 1, CAN has a small number of signal lines and allows a plurality of nodes to be additionally connected easily, providing flexibility in configuring a network. Communication is performed using a differential voltage, so that it is not readily susceptible to external noise. Moreover, various error detection features are also provided. As a result, high reliability is provided. Because of these factors, CAN is widely used in systems in which a large number of nodes are installed in a limited space and high reliability is desired, such as an automobile, for example.

In CAN, it is a general rule that a message having a particular ID is transmitted only by a particular node. However, if an unauthorized node transmits a message with a fake ID, this message cannot be recognized as an unauthorized message because information to identify a transmission node is only an ID in the CAN protocol, causing a receiving node to receive it as an authorized message and malfunction. This is called an impersonation attack of CAN, and is currently considered to be a major problem in the security of automobiles. Such an impersonation attack can be realized, for example, by methods such as altering a program of an ECU (Engine Control Unit) connected to the CAN to an unauthorized program via a network, or additionally connecting an unauthorized ECU to the CAN physically.

Matsumoto et al. proposed a countermeasure method described in Non-Patent Literature 2 and Non-Patent Literature 3 against impersonation attacks of CAN. This countermeasure method makes use of the fact that a node connected to the CAN monitors signal values on the CAN. Specifically, a node immediately inserts an error frame to stop communication of an unauthorized message upon detecting that an ID assigned to the node itself is being transmitted by another node. This countermeasure method has been considered as one of promising countermeasure methods against impersonation attacks of CAN.

Recently, however, it has become known that a short circuit attack to cause a short circuit on the CAN to prevent insertion of an error frame is possible against the countermeasure method of Matsumoto, et al. After proposing the countermeasure method of Non-Patent Literature 2 and Non-Patent Literature 3, Matsumoto, et al. then presented an attack method to electrically forge CAN signals by connecting two lines connected to an unauthorized node in Non-Patent Literature 4. This attack is also included in short circuit attacks.

As conventional techniques for detecting a short circuit on the CAN, there are short circuit detection techniques described in Patent Literature 1, Patent Literature 2, and Patent Literature 3, although not intended for countermeasures against security attacks such as a short circuit attack. As techniques for detecting an unauthorized node on the CAN, there are unauthorized node detection techniques described in Patent Literature 4 and Patent Literature 5.

### CITATION LIST

### Patent Literature

Patent Literature 1: JP 7-43256 A
Patent Literature 2: JP 2006-191404 A
Patent Literature 3: JP 2004-252963 A
Patent Literature 4: JP 2007-36512 A
Patent Literature 5: JP 2014-83874 A

### Non-Patent Literature

Non-Patent Literature 1: Vector, “CAN for beginners”, http://download.vector-japan.co.jp/portal/medien/cmc/beginners/For_Beginners_CAN.p df.
Non-Patent Literature 2: Masato Hata, Masato Tanabe, Kasunari Yoshioka, Kazuomi Oishi, and Tsutomu Matsumoto, “How to Stop Unauthorized Transmission in Controller Area Network”, Computer Security Symposium (CSS) 2011, 3B2-2.
Non-Patent Literature 3: T. Matsumoto, M. Hata, M. Tanabe, K. Yoshioka, and K. Oishi, “A Method of Preventing Unauthorized Data Transmission in Controller Area Network”, Vehicular Technology Conference (VTC Spring), 2012 IEEE 75th, 2012.
Non-Patent Literature 4: Tsutomu Matsumoto, Yoshifumi Nakayama, Taiki Kodatsu, Yuu Tsuchiya, and Katsunari Yoshioka, “Electrical Data Forgery Based on CAN Synchronization Features”, SCIS2015, 2C4-1.

### SUMMARY OF INVENTION

### Technical Problem

A CAN bus has a linear architecture using two signal lines. A state in which the potential difference between the two signal lines is large is called dominant, and a state in which the potential difference is small is called recessive. In the countermeasure method described in Non-Patent Literature 2 and Non-Patent Literature 3, an error frame is inserted by forcibly changing recessive in an unauthorized message to dominant. This functions effectively due to the electrical specification of CAN that when a collision between dominant and recessive occurs, dominant is detected on the CAN, that is, dominant is stronger. However, there has been a problem as follows. If a short circuit can be caused between the two signal lines of the CAN at selective timing, it is possible to make the potential difference between the two signal lines not sufficiently large during dominant. As a result, recessive is detected on the CAN and an error frame cannot be inserted, so that an impersonation attack cannot be prevented.

The technique described in Patent Literature 1 monitors abnormality in a current flowing from a power supply in a vehicle. However, the technique of Patent Literature 1 monitors momentary abnormal changes in the current using a current probe, and thus is not suitable for detecting a non-dynamic abnormal current. That is, if an attacker gradually reduces the impedance between the two CAN lines, an abnormal current cannot be detected and an impersonation attack cannot be prevented.

The technique described in Patent Literature 2 monitors abnormality in the potential difference between the two CAN lines. However, the technique of Patent Literature 2 assumes accidental abnormality such as a failure, and thus is vulnerable to malicious attacks. For example, if an attacker of a short circuit attack acts maliciously such as removing a node device dedicated to monitoring abnormality, a short circuit cannot be detected.

The technique described in Patent Literature 3 aims to identify a short circuit point when a non-dynamic short circuit occurs on the CAN, and is applied in order to manually analyze a failure using a tester. Therefore, a dynamic short circuit such as a short circuit attack cannot be detected.

The techniques described in Patent Literature 4 and Patent Literature 5 aim to detect addition of an unauthorized node to the CAN, and monitor a voltage drop and impedance on the CAN and compare them with pre-stored values. If an attacker of a short circuit attack connects an unauthorized node, the addition of the unauthorized node may be detected with these techniques. However, also in this case, the attacker can connect an unauthorized node by methods such as replacing an authorized node with the unauthorized node or altering an authorized node. Once the unauthorized node is connected, a dynamic short circuit such as a short circuit attack cannot be detected with the techniques of Patent Literature 4 and Patent Literature 5.

As described above, the conventional techniques have problems that a dynamic short circuit such as a short circuit attack cannot be detected and an impersonation attack cannot be prevented.

The present invention has been conceived to solve the above-described problems, and aims to detect a dynamic short circuit such as a short circuit attack and improve the security of the CAN to prevent an impersonation attack.

### Solution to Problem

In order to solve the above-described problems, an attack detection apparatus according to the present invention includes a CAN (Controller Area Network) to transfer a signal to a plurality of nodes by a differential voltage between two signal lines; and a short circuit detector to monitor the signal transferred by the two signal lines of the CAN, and detect a short circuit between the two signal lines on a basis of a change in the signal indicating a characteristic of a short circuit attack by an unauthorized node.

### Advantageous Effects of Invention

According to the present invention, a short circuit between two CAN lines is monitored to detect a short circuit attack, and occurrence of the short circuit attack is notified to each node on the CAN and a system control unit at an upper level, thereby providing the effect of being able to detect a dynamic short circuit such as a short circuit attack and improve the security of the CAN to prevent an impersonation attack.

### BRIEF DESCRIPTION OF DRAWINGS

FIG. 1 is a diagram illustrating an example of the configuration of an attack detection apparatus according to a first embodiment;

FIG. 2 is a diagram illustrating the configuration of a CAN bus;

FIG. 3 is a diagram illustrating signal levels of high-speed CAN;

FIG. 4 is a diagram illustrating a data frame in the CAN standard format;

FIG. 5 is a diagram illustrating a conventional method of countermeasure against an impersonation attack;

FIG. 6 is a diagram illustrating an example (No. 1) of implementation of a short circuit attack;

FIG. 7 is a diagram illustrating an example (No. 2) of implementation of a short circuit attack;

FIG. 8 is a diagram illustrating signal levels due to a short circuit attack;

FIG. 9 is a diagram illustrating an example of the configuration of a countermeasure node 2 that monitors a potential difference;

FIG. 10 is a diagram illustrating an example of the configuration of a countermeasure node 2 that monitors impedance;

FIG. 11 is a diagram illustrating an example of the configuration of an impedance monitor 11;

FIG. 12 is a diagram illustrating an example of the configuration in a case where a current is monitored; and

FIG. 13 is a diagram illustrating an example of the configuration of an attack monitoring apparatus that monitors CANs in a plurality of domains.

### DESCRIPTION OF EMBODIMENTS

### First Embodiment

In this embodiment, an outline of CAN and a short circuit attack in detail will be described first. Then, the configuration and operation of an attack detection apparatus according to this embodiment will be described.

<Outline of CAN>

FIG. 2 is a diagram illustrating the configuration of a CAN bus.

The CAN bus has a linear architecture using two signal lines CAN_H and CAN_L, and is terminated at each end with 120Ω. A plurality of nodes, namely a node 1 to a node n, are each connected to the CAN bus via a CAN transceiver. These nodes can access the bus equally according to a multi-master method. In CAN, serial communication is performed by transferring a signal by a differential voltage between CAN H and CAN L.

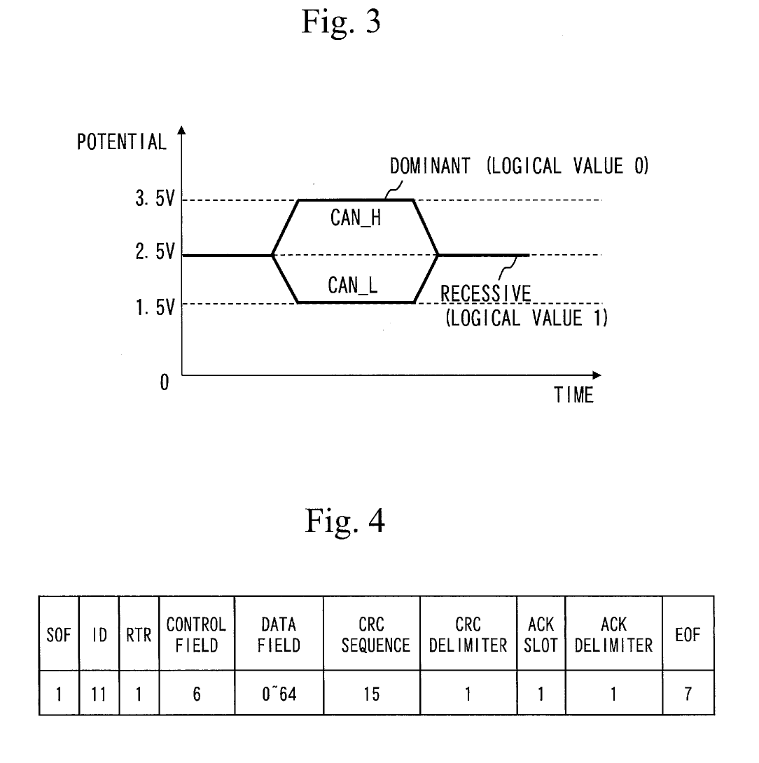

FIG. 3 is a diagram illustrating signal levels of high-speed CAN.

As illustrated in FIG. 3, a state in which the potential difference between two CAN_H and CAN_L is large is called dominant and represents a logical value 0. A state in which the potential difference between the two is small is called recessive and represents a logical value 1.

In CAN, there is no dedicated signal line for performing arbitration before communication is started, so that a plurality of nodes may start transmission at the same time. In such a case, arbitration is performed as described below. It is important here that when different nodes transmit dominant and recessive, respectively, the state on the CAN becomes dominant (for details, refer to the international specification of CAN, Non-Patent Literature 1, etc.). It is arranged that each node monitors signals on the CAN, and upon detecting a signal value different from a signal value each node itself has transmitted, the node that has transmitted recessive stops transmitting and only the node that has transmitted dominant continues transmitting. With this arrangement, arbitration is realized.

CAN communication is performed in units of a time-series bit sequence called a frame. There are frames of a plurality of types, and one that is mainly used is a data frame illustrated in FIG. 4.

FIG. 4 is a diagram illustrating the data frame in the CAN standard format. The data frame is divided into a plurality of fields. For example, SOF and EOF of FIG. 4 are fields representing the start and the end of the frame, respectively. A data field of FIG. 4 is a field in which data to be transmitted and received is stored. Each field is described in detail in Non-Patent Literature 1 and the like. One that is particularly pertinent to the present invention is an ID field. The ID field is a field for identifying data content and a transmission node and is also used in the above-described arbitration. The value of the ID field determines which node on the CAN has transmitted the frame, which node should receive the frame, what processing should be performed by the node receiving this frame, and the like. The values of the ID field are pre-defined for each CAN by a system designer or the like. As a general rule, the values of the ID field must be assigned such that a frame having a particular ID value is transmitted only by a particular node. Communication that is realized by a frame will hereinafter be called a message.

<Short Circuit Attack in Detail>

A short circuit attack against the CAN will now be described in detail.

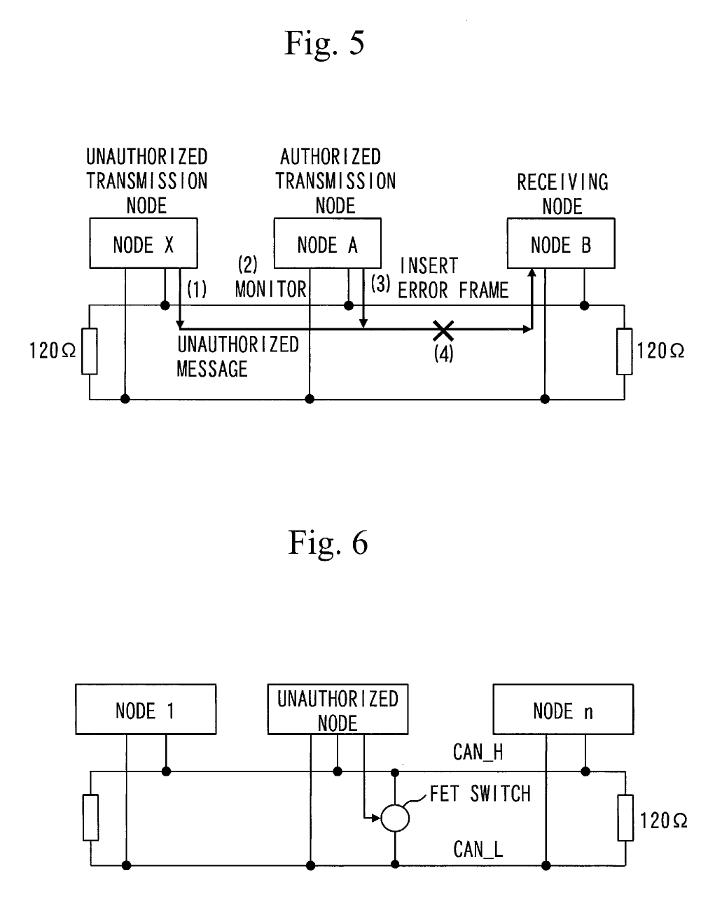

First, a conventional method of countermeasure against an impersonation attack described in Non-Patent Literature 2 and Non-Patent Literature 3 will be described with reference to FIG. 5.

FIG. 5 is a diagram illustrating a conventional method of countermeasure against an impersonation attack.

In FIG. 5, it is assumed that a node X connected to the CAN is an unauthorized transmission node. The node X starts transmitting an unauthorized message using an ID assigned to a node A which is an authorized transmission node (1). The node A monitors signal values on the CAN (2), and upon detecting that the ID of the frame is the value assigned to the node A itself, inserts an error frame into this message (3). The error frame consists of six consecutive dominant bits. In CAN, when six or more consecutive bits of the same bit value appear during communication, this is considered as an error. As described above, when a collision between dominant and recessive occurs, dominant is detected on the CAN, so that recessive transmitted by the node X at the same timing is overridden. As a result, a node B detects the error frame during communication, and the communication of the unauthorized message is invalidated (4).

Next, a short circuit attack against the conventional method of countermeasure against an impersonation attack will be described.

FIG. 6 is a diagram illustrating an example (No. 1) of implementation of a short circuit attack.

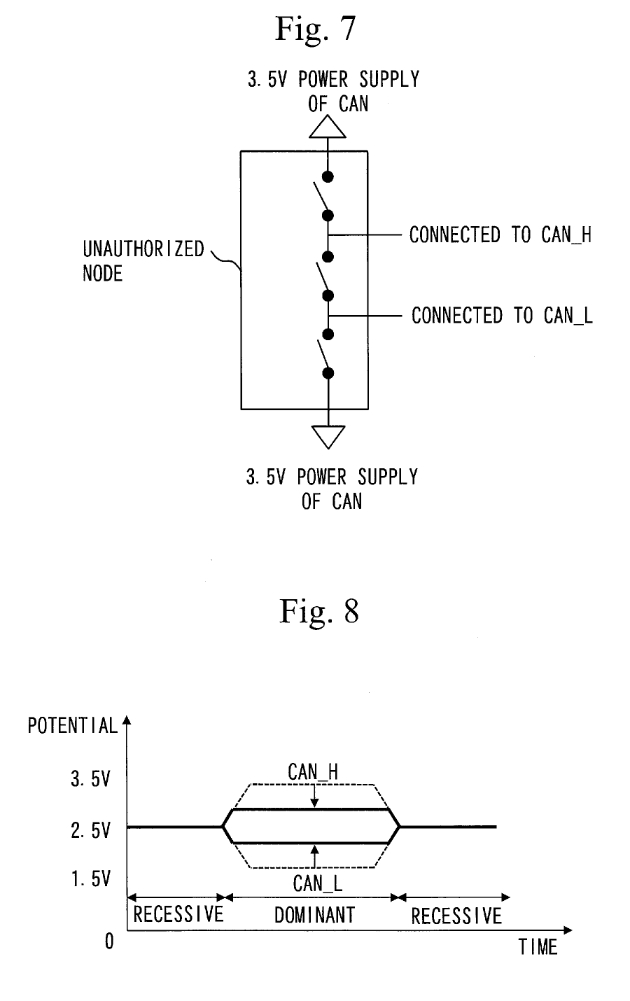

FIG. 7 is a diagram illustrating an example (No. 2) of implementation of a short circuit attack.

FIG. 8 is a diagram illustrating signal levels due to a short circuit attack.

In FIG. 6, a short circuit attack is realized by inserting an FET switch between CAN_H and CAN_L and controlling ON and OFF of the FET switch by an unauthorized node connected to the CAN. The unauthorized node monitors signal values of the CAN and sets the FET switch to ON at the desired timing of an attacker to forcibly turn dominant transmitted by another node into recessive, as illustrated in FIG. 8. In FIG. 8, dotted lines indicate a case without a short circuit attack, and solid lines indicate a case with a short circuit attack. It can be seen that the short circuit attack reduces the potential difference between CAN_H and CAN_L during dominant, causing dominant transmitted by another node to be forcibly turned into recessive.

FIG. 7 is a case in which substantially the same function as FIG. 6 is implemented internally in the unauthorized node. In this case, unlike in FIG. 6, the attacker does not need to modify the CAN to insert the FET switch and only needs to add the unauthorized node to the CAN.

When the countermeasure method of Non-Patent Literature 2 and Non-Patent Literature 3 is implemented on a regular CAN, if the attacker transmits an unauthorized message with a certain ID, a node which is an authorized transmitter of this ID transmits six consecutive dominant bits, thereby turning subsequent recessive in the unauthorized message to dominant so that it becomes an error frame. That is, the unauthorized message is invalidated.

On the other hand, as described above, in the CAN modified to allow a short circuit between the two CAN lines at selective timing, when the attacker transmits an unauthorized message, the attacker controls the switch to be set to ON at a bit which the attacker wants to be recessive. A short circuit occurs between the two lines during this ON period, and even if another node transmits dominant to insert an error message during transmission of the unauthorized message, it is recognized as recessive by a receiver, as intended by the attacker.

In addition to hindering insertion of an error frame, a short circuit attack can also be used to alter data included in a message transmitted by an authorized node. Recessive data can be altered to dominant by means other than the short circuit attack, but the short circuit attack allows arbitrary alteration in both directions. However, in either case, the attacker needs to alter data such that no CRC error occurs, or needs to also alter a CRC field.

Unlike a remote attack via a network, the attacker of a short circuit attack is limited to a person who can touch the target to be attacked. In the case of an automobile, countermeasures to reduce occasions to be attacked by unspecified third parties can be considered, such as locking the doors without fail when a user leaves the automobile, and the like. However, when there are a plurality of users such as with a rental car or a shared car, such countermeasures are ineffective if one user performs such an attack to inflict damage on another user. There is also a possibility that a user becomes an attacker against the CAN for its own sake. For example, it is possible for the user to disguise the engine revolution speed so as to not decrease the travel speed. Thus, countermeasures are needed against sophisticated attacks in which the attackers are limited, such as a short circuit attack. The present invention provides means for that.

The attack detection apparatus according to a first embodiment will now be described.

First, an outline of the attack detection apparatus will be described. The attack detection apparatus improves the security of the CAN by realizing the following three functions concerning short circuit attacks.

(a.) Detection by electrical means of occurrence of a short circuit attack.

(b.) Notification of occurrence of a short circuit attack to a CAN node and a system control unit at an upper level.

(c.) Identification of a domain where a short circuit attack has occurred.

For detection of occurrence of a short circuit attack of the above (a.), there are three forms of implementation: monitoring a potential difference, monitoring impedance, and monitoring a current. For notification of a short circuit attack of the above (b.), there are two forms of implementation: broadcasting by a CAN message (notification to a node on the CAN) and notification using a channel other than the CAN (notification to the system control unit). With regard to identification of a domain of the above (c.), in a system such as an automobile, there are generally CANs in a plurality of domains sharing two CAN power supplies (3.5 V and 1.5 V). In such a system, if one domain receives a short circuit attack, there is a possibility that the domain where the short circuit attack has occurred cannot be identified by simply monitoring short circuits in each domain. The above-mentioned form of implementation of (c.) allows identification of the domain that has received the attack.

### First Embodiment

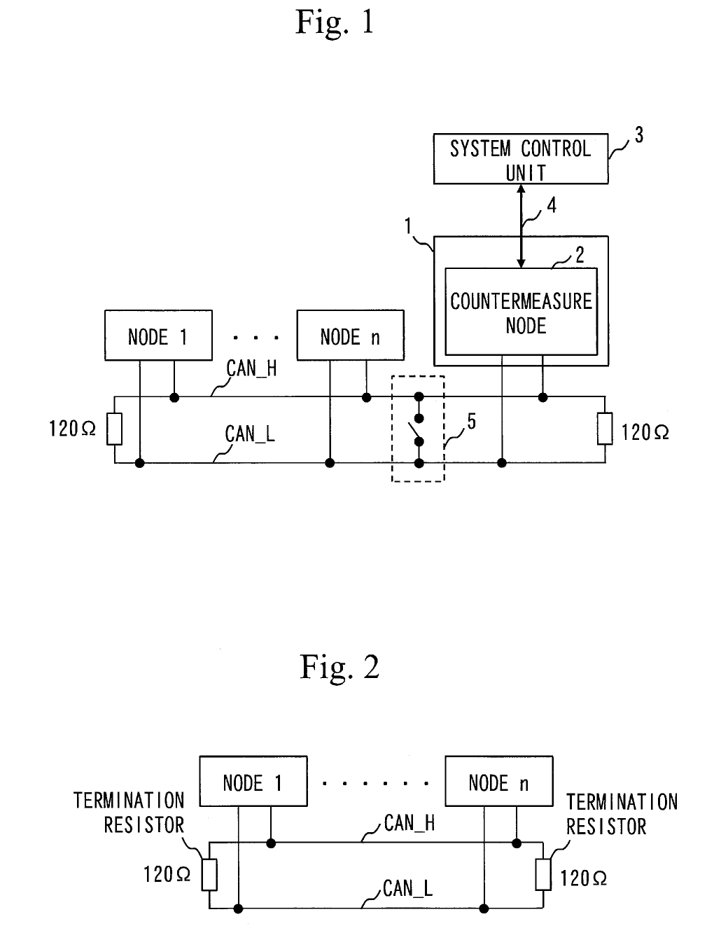

FIG. 1 is a diagram illustrating an example of the configuration of the attack detection apparatus according to the first embodiment.

With reference to FIG. 1, an attack detection apparatus 1 has a countermeasure node 2. The countermeasure node 2 is an example of a short circuit detector. The attack detection apparatus 1 is connected to a system control unit 3 via a communication channel 4. A portion indicated by dotted lines on a CAN bus is a short circuit attack source 5 that simulates a short circuit attack. The short circuit attack source 5 comes into existence when a system has become the target of a short circuit attack.

Compared with FIG. 2 illustrating the configuration of a conventional CAN, FIG. 1 includes not only the existing node 1 to node n, but also the countermeasure node 2 which is added for a countermeasure against a short circuit attack. The countermeasure node 2 is connected to the CAN in the same manner as the other existing node 1 to node n. As a matter of course, it is also possible to add a countermeasure function against a short circuit attack equivalent to the countermeasure node 2 of FIG. 1 to any one of the existing node 1 to node n, without increasing the number of nodes.

The countermeasure node 2 is a node that monitors, detects and notifies a short circuit attack. The countermeasure node 2 monitors a signal transmitted by the two signal lines of the CAN, and detects a short circuit between the two signal lines on the basis of a change in the signal that indicates the characteristic of a short circuit attack by an unauthorized node. A specific method for implementing the monitoring, detection, and notification of a short circuit attack will be described later.

The system control unit 3 manages the system state and security of the entire automobile, including the CAN.

The communication channel 4 is a channel for notifying the system control unit 3 of occurrence of a short circuit attack without fail. The communication channel 4 is not defined in CAN of conventional art, and it is a communication channel newly provided in this embodiment.

The operation of the attack detection apparatus 1 according to the first embodiment will now be described.

First, at start-up of the system including the CAN, it is checked that the countermeasure node 2 is properly connected to the CAN in a configuration at start-up of the system, so as to protect against a threat of detachment of the countermeasure node 2 by an attacker when modifying the CAN to be attacked or adding an unauthorized node in order to cause a short circuit attack to occur. Several means of checking are possible. For example, a CAN message to query each node whether each node exists on the CAN may be defined, and this CAN message may be transmitted to each node. Alternatively, for example, the existence of the countermeasure node 2 may be checked by performing communication between the system control unit 3 and the countermeasure node 2 using the communication channel 4. Note that in order to protect the countermeasure node 2 from being faked, it is desirable to use authentication means in view of information security, for example, a challenge-response authentication method. It is still more desirable that the countermeasure node 2 and the communication channel 4 be surrounded solidly so as not to be altered physically.

The monitoring operation of short circuit attacks in the attack detection apparatus 1 will now be described.

As a method for electrically detecting a short circuit between the two CAN lines, the following three types can be conceived: monitoring a potential difference, monitoring impedance, and monitoring a current. In the first embodiment, the monitoring operation of short circuit attacks by monitoring a potential difference will be described.

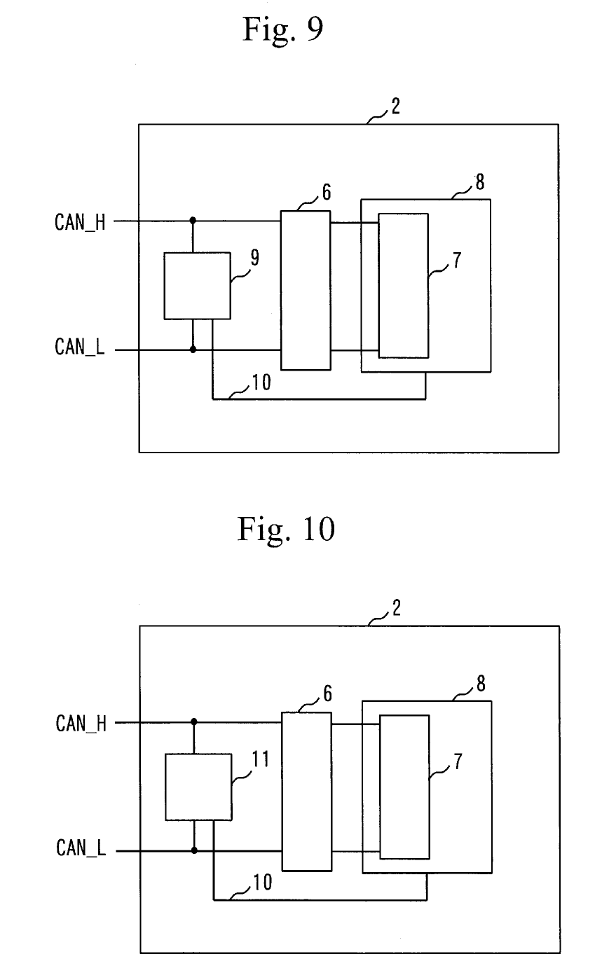

FIG. 9 is a diagram illustrating an example of the configuration of the countermeasure node 2 that monitors a potential difference.

With reference to FIG. 9, the countermeasure node 2 of the attack detection apparatus 1 has a CAN transceiver 6, a CAN protocol controller 7, an ECU (Engine Control Unit) 8, an AD converter 9, and an ECU communication channel 10.

The CAN transceiver 6, the CAN protocol controller 7, and the ECU 8 of FIG. 9 are normally provided in a node connected to the CAN. In this embodiment, in addition to these, the AD converter 9 is provided to monitor the potential difference between the two CAN lines. The AD converter 9 is an electronic circuit that converts an analog electrical signal into a digital electrical signal. The two CAN lines are connected to the AD converter 9 herein, such that the potential difference between the two CAN lines becomes an analog electrical signal to be input to the AD converter 9.

The ECU 8 and the AD converter 9 communicate via the ECU communication channel 10. Note that any element or circuit may be used as long as the potential difference between the two lines can be transferred to the ECU 8 as a digital signal, and it is not limited to the AD converter 9.

The countermeasure node 2 detects a short circuit attack as described below, for example. The ECU 8 regularly reads the potential difference between the two CAN lines which has been converted into digital data by the AD converter 9. The countermeasure node 2 monitors the potential difference between the two signal lines of the CAN, and detects a short circuit between the two signal lines if the potential difference is in a range indicating the characteristic of a short circuit attack. Specifically, if the value of the potential difference read from the AD converter 9 is a value in a predetermined range a fixed number of times or more in succession, the countermeasure node 2 considers that a short circuit has occurred between the two lines by a short circuit attack, and notifies each node on the CAN and the system control unit 3 at the upper level. As illustrated in FIG. 8, when dominant is altered to recessive by a short circuit attack, the potential difference between the two CAN lines becomes larger than the normal potential difference during recessive and smaller than the normal potential difference during dominant. Thus, the above-mentioned predetermined range is set to a range of this potential difference during altered dominant.

Next, a method for notifying occurrence of a short circuit attack when the attack detection apparatus 1 has detected a short circuit attack will be described. When a short circuit attack is received, it is necessary to notify each node on the CAN and the system control unit 3 at the upper level of occurrence of the short circuit attack as quickly as possible, in order to prevent serious damage. First, in order to notify each node on the CAN, the countermeasure node 2 broadcasts the occurrence of the short circuit attack to each node on the CAN. In order to implement this, an ID for notifying a short circuit attack is pre-defined in message IDs of the CAN. As a general rule, each node is implemented such that a message having the ID for notifying a short circuit attack is transmitted by the countermeasure node 2 and is received by every node. At least, a node for which there is a possibility that malfunction may lead to serious damage is implemented to accept a message having the ID for notifying a short circuit attack and perform appropriate operation. What constitutes the appropriate operation depends on the system, so that the appropriate operation is implemented in accordance with the functionality of the system.

When notification is performed by broadcasting, a message authentication technique of CAN may be used in combination in order to prevent an unauthorized node from transmitting a short circuit attack notification message even though no short circuit attack has occurred.

In this way, the above-described notification by broadcasting makes it possible to notify each node on the CAN of an attack by only additionally implementing one ID for notifying a short circuit attack in the message IDs. Thus, a short circuit attack can be notified at low cost.

Next, another method for notifying occurrence of a short circuit attack will be described.

The above-described notification by broadcasting is communicated using the CAN which has been the target of the short circuit attack, and thus may potentially have insufficient reliability. That is, if a short circuit attack notification message itself upon detection of a short circuit attack is subject to another short circuit attack again, there is a possibility that notification may not be performed properly. However, the most important is notifying the system control unit 3, which is at the upper level than the CAN, of the occurrence of the attack without fail. Thus, as illustrated in FIG. 1, the communication channel 4 is provided specifically to notify detection of a short circuit attack from the countermeasure node 2 connected with the CAN to the system control unit 3 at the upper level. The communication channel 4 is a communication channel different from the CAN, so that it is possible to notify the system control unit 3 without using the CAN with damaged reliability as a result of receiving the short circuit attack. The protocol of the communication channel 4 and a method of physical implementation thereof, such as wired or wireless, are not limited in any way. However, the following arrangements are desirable in order to make it difficult for the communication channel 4 itself to be attacked.
The communication channel is surrounded by a solid fence.
In the case of wired implementation, the communication channel is implemented using a plurality of signal lines.
The system control unit 3 authenticates the countermeasure node 2 using authentication means in view of information security.

As described above, the attack detection apparatus according to the first embodiment monitors a short circuit between the two CAN lines to detect a short circuit attack, and notifies each node on the CAN and the system control unit at the upper level of occurrence of the short circuit attack, and thereby provides the effect of being able to detect a dynamic short circuit such as a short circuit attack, and improve the security of the CAN to prevent an impersonation attack.

### Second Embodiment

In the first embodiment, the case where a short circuit attack is detected by monitoring the potential difference between the two CAN lines has been described. An embodiment in which a short circuit attack is detected by monitoring the impedance between the two CAN lines will now be described.

FIG. 10 is a diagram illustrating an example of the configuration of a countermeasure node 2 that monitors impedance.

In FIG. 10, an impedance monitor 11 is installed in place of the AD converter 9 of FIG. 9. The rest of the configuration is the same as in FIG. 9.

In this embodiment, the impedance between the two CAN lines is measured by the impedance monitor 11.

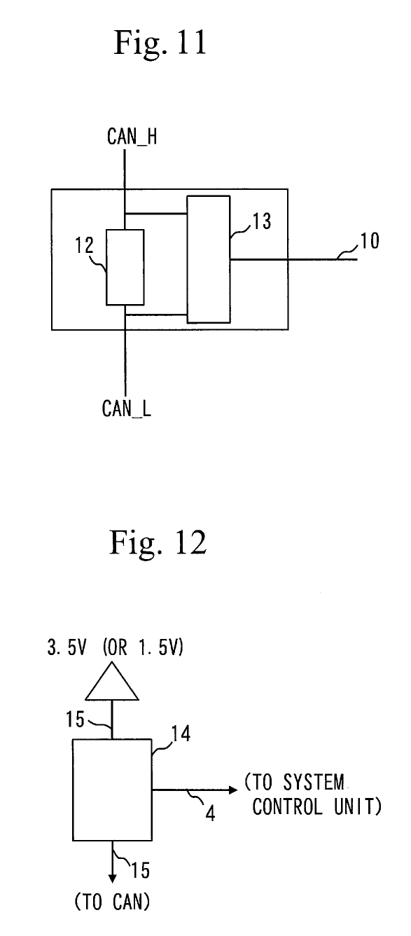

FIG. 11 is a diagram illustrating an example of the configuration of the impedance monitor 11.

With reference to FIG. 11, the impedance monitor 11 has a resistor 12 and an AD converter 13. Note that the impedance monitor 11 is not limited to the configuration of FIG. 11 as long as it is a circuit or element that can measure the impedance between the two CAN lines and transmit a measurement result as digital information to the ECU.

Normally, during transmission of dominant on the CAN, the power supplies of 3.5 V and 1.5 V are connected via two termination resistors of 120Ω. Thus, if the countermeasure node 2 of FIG. 10 is not present, a current of approximately 33 mA flows between the two power supplies. The resistor 12 of FIG. 11 has a sufficiently large resistance value so as to have no adverse effect on the operation of the CAN. Assuming that this resistance value is R [Ω], a current of 33*(60/(60+R)) [mA] flows through this resistor during transmission of dominant when the countermeasure node 2 of FIG. 10 is connected.

On the other hand, during transmission of recessive on the CAN, the two power supplies of 3.5 V and 1.5 V are electrically disconnected normally. Thus, almost no current flows through the resistor 12 of FIG. 11. However, if a short circuit attack occurs, recessive is detected on the CAN but a current flows through the two power supplies. In the short circuit attack, the impedance between the two CAN lines becomes a very small value (assumed to be r[Ω]) but not 0. Thus, when the countermeasure node 2 of FIG. 10 is connected, a current in accordance with the ratio of R to r flows through the resistor 12 of FIG. 11. Accordingly, by measuring the potential difference between both ends of the resistors 12 by the AD converter 13 of FIG. 11, the impedance between the two CAN lines can be known indirectly. That is, it is approximately 60 Ω during normal dominant, a very large value during normal recessive, and a very small value during recessive by a short circuit attack. The ECU 8 of FIG. 10 monitors the impedance when recessive is detected on the CAN, and if the impedance between the two CAN lines is smaller than a predetermined value, considers that a short circuit attack is detected and performs notification.

### Third Embodiment

In the second embodiment, the case in which a short circuit attack is detected by monitoring the impedance between the two CAN lines has been described. An embodiment in which a short circuit attack is detected by monitoring the current between the two CAN lines will now be described.

FIG. 12 is a diagram illustrating an example of the configuration in a case in which a current is monitored.

Unlike the case where the potential difference or impedance is monitored, this embodiment is not implemented inside the countermeasure node 2, but is implemented on a power supply circuit of the system using the CAN, or on a power supply line or a power supply cable connecting the power supply circuit and the CAN. This is because even if the current flowing in a particular node connected to the CAN is monitored, the all currents flowing between the two CAN power supplies (3.5 V and 1.5 V) is not monitored.

With reference to FIG. 12, a current monitor 14 is inserted in series on a power supply line 15 which connects the CAN power supplies and the CAN, so as to monitor the current flowing between the power supplies and the CAN. The current monitor 14 is an example of a short circuit detector. To prevent a large voltage drop inside the current monitor 14, the internal resistance of the current monitor 14 needs to be set to a very small value. As described above, normally, a current of approximately 33 mA flows between the power supplies when the CAN state is dominant, and almost no current flows when recessive. However, the impedance between the two CAN lines becomes a very small value during recessive by a short circuit attack, so that an extremely high current flows between the power supplies. When such a high current is detected for a duration exceeding a specified period, the current monitor 14 of FIG. 12 considers that a short circuit attack is detected and notifies the system control unit 3. Even when a short circuit attack is not received, there is a possibility that a high current may momentarily flow when the CAN state switches to dominant. However, in the case of a short circuit attack, a high current flows continuously at least for the duration of transferring one bit, so that the two cases can be distinguished.

### Fourth Embodiment

In the first to third embodiments, the cases in which a short circuit attack is detected by monitoring the potential difference, impedance, current, or the like between the two CAN lines have been described. An embodiment in which when there are CANs in a plurality of domains, the domain where a short circuit attack has occurred can be identified will now be described.

There may be a case in which CANs in a plurality of domains that share the two CAN power supplies (3.5 V and 1.5 V) exist in one system. If one of the domains receives a short circuit attack in such a system, there is a possibility that the domain where the short circuit attack has occurred cannot be identified by monitoring the potential difference or impedance between the two CAN lines in each domain individually, as in the first to third embodiments. For example, if dominant is transmitted at the same time in each of CANs in two domains and the CAN in one of the domains receives a short circuit attack, the potential difference or impedance between the two lines in the other domain may also indicate a value in an abnormal range as in the domain that has received the attack. In this case, it is difficult to identify the domain that has received the attack. An example of implementation for solving this problem will be described.

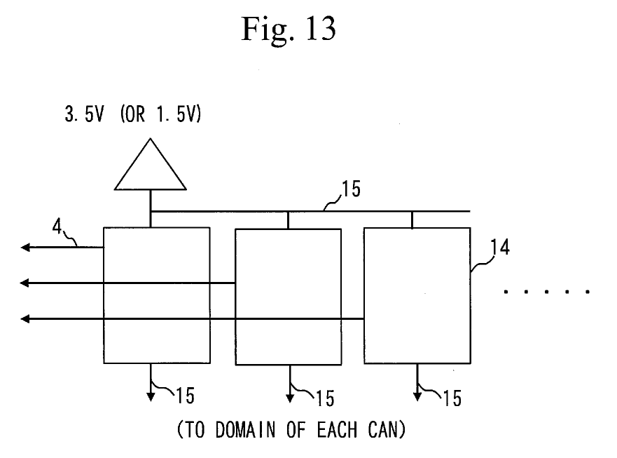

FIG. 13 is a diagram illustrating an example of the configuration of an attack monitoring apparatus that monitors CANs in a plurality of domains.

The configuration of FIG. 13 is one in which the configuration in the case of monitoring the current described in the third embodiment is applied. In this configuration, a current monitor 14 is inserted in series in each domain on a power supply line 15 connecting the CAN power supplies and each CAN domain, and monitors the current flowing between the power supplies and the CAN in each domain. As in the third embodiment, the current monitor 14 of each domain monitors a high current due to a short circuit attack, and when a high current is detected over a duration exceeding a specified period, considers that the domain has received a short circuit attack and notifies a system control unit 3. The notification to the system control unit 3 is performed using a communication channel 4 for notifying a short circuit attack provided in each domain.

By configuring the attack monitoring apparatus as described above, even when CANs in a plurality of domains share the power supplies, it is possible to identify the domain where a short circuit attack has occurred.

### REFERENCE SIGNS LIST

1: attack detection apparatus, 2: countermeasure node, 3: system control unit, 4: communication channel, 5: short circuit attack source, 6: CAN transceiver, 7: CAN protocol controller, 8: ECU (Engine Control Unit), 9: AD converter, 10: ECU communication channel, 11: impedance monitor, 12: resistor, 13: AD converter, 14: current monitor, 15: power supply line

1. An attack detection apparatus comprising:
a CAN (Controller Area Network) to transfer a signal to a plurality of nodes by a differential voltage between two signal lines; and
a short circuit detector to monitor the signal transferred by the two signal lines of the CAN, and detect a short circuit between the two signal lines on a basis of a change in the signal indicating a characteristic of a short circuit attack by an unauthorized node.

2. The attack detection apparatus according to claim 1,
wherein the short circuit detector monitors a potential difference between the two signal lines of the CAN, and detects the short circuit between the two signal lines if the potential difference is in a range indicating the characteristic of the short circuit attack.

3. The attack detection apparatus according to claim 1,
wherein the short circuit detector monitors impedance between the two signal lines of the CAN, and detects the short circuit between the two signal lines if the impedance is in a range indicating the characteristic of the short circuit attack.

4. The attack detection apparatus according to claim 1,
wherein the short circuit detector monitors a current between the two signal lines of the CAN, and detects the short circuit between the two signal lines if the current is in a range indicating the characteristic of the short circuit attack.

5. The attack detection apparatus according to claim 4,
wherein the short circuit detector monitors currents of a plurality of CANs existing in a plurality of domains, and identifies one of the domains in which a short circuit indicating the characteristic of the short circuit attack is detected.

6. The attack detection apparatus according to claim 1,
wherein when the short circuit detector has detected the short circuit indicating the characteristic of the short circuit attack, one of the nodes notifies another node of a message indicating occurrence of the short circuit attack.

7. The attack detection apparatus according to claim 1, further comprising:
processing circuitry to manage a state of a system at an upper level of the CAN; and
a communication channel to connect the processing circuitry and the short circuit detector,
wherein upon detecting the short circuit indicating the characteristic of the short circuit attack, the short circuit detector notifies the processing circuitry of a message indicating occurrence of the short circuit attack via the communication channel.
